(19) United States
(12) Patent Application Publication
(10) Pub. No.: US 2020/0033975 A1
(43) Pub. Date: Jan. 30, 2020

(54) TOUCH PANEL, DISPLAY DEVICE, METHOD FOR FABRICATING THE TOUCH PANEL

(71) Applicants: Hefei Xinsheng Optoelectronics Technology Co., Ltd., Hefei (CN); BOE Technology Group Co., Ltd., Beijing (CN)

(72) Inventors: Tengfei ZHONG, Beijing (CN); Bin PANG, Beijing (CN); Yuan LI, Beijing (CN); Shifeng XU, Beijing (CN); Min HE, Beijing (CN)

(73) Assignees: Hefei Xinsheng Optoelectronics Technology Co., Ltd.; BOE Technology Group Co., Ltd.

(21) Appl. No.: 16/399,061

(22) Filed: Apr. 30, 2019

(30) Foreign Application Priority Data
Jul. 25, 2018 (CN) 201810827825.9

(51) Int. Cl. G06F 3/041

(52) U.S. Cl. CPC G06F 3/0412; G06F 2203/04107; G06F 2203/04103

(57) ABSTRACT

A touch panel, a display device and a method for fabricating the touch panel are provided. The touch panel includes: a base substrate; a light-shielding layer on the base substrate and corresponding to an invisible area; a first insulating medium layer on the light-shielding layer; a second insulating medium layer on the first insulating medium layer, wherein an orthographic projection of the second insulating medium layer on the base substrate covers an orthographic projection of the light-shielding layer on the base substrate; and a first metal pattern layer on the second insulating medium layer.

### CROSS-REFERENCES TO RELATED APPLICATIONS

This application claims priority to Chinese patent application No. 201810827825.9 filed on Jul. 25, 2018, which is incorporated herein by reference in its entirety.

### FIELD

The present disclosure relates to the field of display technologies, and particularly to a touch panel, a display device, a method for fabricating the touch panel.

### BACKGROUND

A One-Glass-Solution (OGS) product with superior performance has been widely applied. However the Electro-Static Discharging (ESD) incurred damage in a fabrication process of the OGS product, e.g., an OGS touch panel, etc., is a significant factor resulting in a defect of the product, and often difficult to prevent and handle. For example, an ESD damage may tend to occur in wires at a BM layer (Black Matrix, also known as the light-shielding layer) of the OGS touch panel (the BM layer is made of a photo-resist material, where the photo-resist material generally includes an insulating material wrapping carbon particles, and it is typically such an insulating material that is easily destroyed in structure at high temperature or due to ESD or another factor while being fabricated, so that the warped carbon particles are exposed, and thus the BM layer becomes a conductor, thus resulting in short-circuiting in a channel), thus resulting in a poor appearance of the OGS touch panel, and degrading the OGS touch panel in function.

### SUMMARY

In one aspect, an embodiment of the disclosure provides a touch panel. The touch panel includes a base substrate; a light-shielding layer on the base substrate and corresponding to an invisible area; a first insulating medium layer on the light-shielding layer; a second insulating medium layer on the first insulating medium layer, wherein an orthographic projection of the second insulating medium layer on the base substrate covers an orthographic projection of the light-shielding layer on the base substrate; and a first metal pattern layer on the second insulating medium layer.

In some embodiments, a width of the orthographic projection of the second insulating medium layer on the base substrate is more than a width of the orthographic projection of the light-shielding layer on the base substrate, in a direction from the invisible area to a visible area.

In some embodiments, the width of the orthographic projection of the second insulating medium layer on the base substrate is more than the width of the orthographic projection of the light-shielding layer on the base substrate by 25 μm to 35 μm, in the direction from the invisible area to the visible area.

In some embodiments, the touch panel further includes: a third insulating medium layer on the first metal pattern layer; a second metal pattern layer on the third insulating medium layer; and a protecting layer on the second metal pattern layer.

In another aspect, an embodiment of the disclosure further provides a display device including the touch panel according to the technical solution above.

In another aspect, an embodiment of the disclosure further provides a method for fabricating the touch panel. The method includes: coating a photo-resist material layer on a base substrate, and patterning the photo-resist material layer to form a light-shielding layer corresponding to an invisible area; forming a first insulating medium layer on the light-shielding layer; forming a second insulating medium layer on the first insulating medium layer, wherein an orthographic projection of the second insulating medium layer on the base substrate covers an orthographic projection of the light-shielding layer on the base substrate; and forming a first metal pattern layer on the second insulating medium layer.

In some embodiments, a width of the orthographic projection of the second insulating medium layer on the base substrate is more than a width of the orthographic projection of the light-shielding layer on the base substrate, in the direction from the invisible area to the visible area.

In some embodiments, forming the second insulating medium layer on the first insulating medium layer includes: forming a second insulating material layer on the first insulating medium layer; exposing the second insulating material layer using a mask used for fabricating the light-shielding layer, and increasing the exposing to enable an edge of the formed second insulating medium layer to go beyond an edge of the light-shielding layer in the direction from the invisible area to the visible area; and removing an unexposed part of the second insulating material layer, to form the second insulating medium layer.

In some embodiments, the width of the orthographic projection of the second insulating medium layer on the base substrate is more than the width of the orthographic projection of the light-shielding layer on the base substrate by 25 μm tm to 35 μm, in the direction from the invisible area to the visible area.

In some embodiments, the method further includes: forming a third insulating medium layer on the first metal pattern layer; forming a second metal pattern layer on the third insulating medium layer; and forming a protecting layer on the second metal pattern layer.

### BRIEF DESCRIPTION OF THE DRAWINGS

FIG. 1 is a schematic structural diagram of a touch panel according to an embodiment of the disclosure; and

FIG. 2 is a schematic flow chart of a method for fabricating the touch panel according to an embodiment of the disclosure.

### DETAILED DESCRIPTION

The technical solutions according to the embodiments of the disclosure will be described below clearly and fully with reference to the drawings in the embodiments of the disclosure. Apparently the embodiments to be described are only a part but all of the embodiments of the disclosure. Based upon the embodiments here of the disclosure, all of other embodiments which can occur to those ordinarily skilled in the art without any inventive effort shall come into the scope of the disclosure as claimed.

The disclosure provides a touch panel, a display device and a method for fabricating the touch panel. In the touch panel above, the second insulating medium layer is added on the light-shielding layer, and the second insulating medium layer can completely cover the light-shielding layer, thus effectively increasing the thickness of the insulating medium layer between the light-shielding layer and the first metal pattern layer, and particularly the thickness of the insulating medium layer at a breakpoint of the edge of the light-shielding layer toward to the visible area, so as to improve the anti-static breakdown performance in the area of the light-shielding layer, and effectively lower the risk of a breakdown of the insulating medium layer on the light-shielding layer; and the thickness of the insulating medium layer in the visible area isn't increased as a whole, and no color cast can occur.

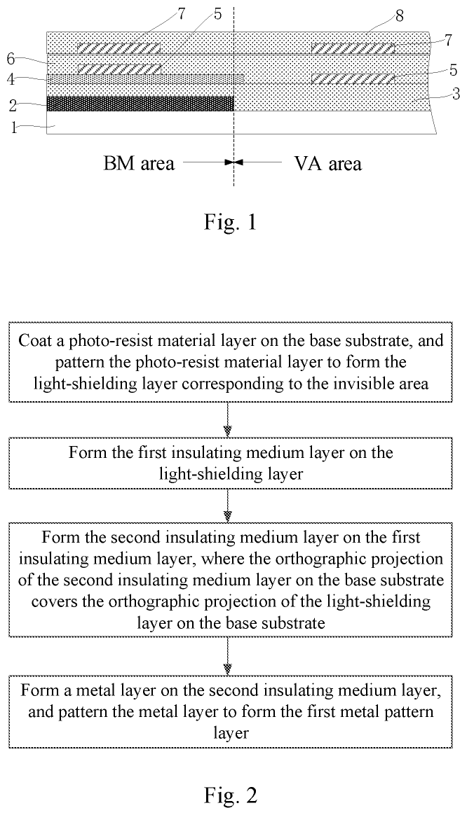

Referring to FIG. 1, a BM area represents an invisible area of a touch panel, and a VA area represents a visible area of the touch panel. A touch panel according to an embodiment of the disclosure includes: a base substrate 1; a light-shielding layer 2 (for example, Black Matrix layer) on the base substrate 1 and corresponding to an invisible area; a first insulating medium layer 3 on the light-shielding layer 2; a second insulating medium layer 4 on the first insulating medium layer 3, where an orthographic projection of the second insulating medium layer 4 on the base substrate 1 covers an orthographic projection of the light-shielding layer 2 on the base substrate 1; and a first metal pattern layer 5 on the second insulating medium layer 4.

In the touch panel above, the base substrate 1 has a visible area and an invisible area, the invisible area is around the visible area, and the light-shielding layer 2 corresponding to the invisible area is arranged on the base substrate 1; and the first insulating medium layer 3 is formed on the light-shielding layer 2 to isolate the light-shielding layer 2 from the first metal pattern layer 5, where the second insulating medium layer 4 corresponding to the light-shielding layer 2 is further arranged between the first insulating medium layer 3 and the first metal pattern layer 5 to completely shield the light-shielding layer 2, that is, both the thickness of the insulating medium layer on the light-shielding layer 2, and the thickness of the insulating medium layer at the edge of the light-shielding layer 2 toward to the visible area are increased, to thereby effectively avoid a breakdown arising from electrostatic discharging on metal wires in the invisible area, so as to improve the anti-static breakdown performance in the area of the light-shielding layer, and particularly the thickness of the insulating medium layer at a breakpoint of the edge of the light-shielding layer toward to the visible area is increased, to thereby effectively lower the risk of a breakdown of the insulating medium layer on the light-shielding layer 2. Moreover the second insulating medium layer 4 only corresponds to the light-shielding layer 2 and shields the light-shielding layer 2, that is, the second insulating medium layer 4 is not arranged below the first metal pattern layer 5 in the visible area of the touch panel, so the thickness of the insulating medium layer in the visible area isn't increased as a whole, and no color cast can occur.

Accordingly in the touch panel above, the second insulating medium layer 4 is added on the light-shielding layer 2, and the second insulating medium layer 4 can completely shield the light-shielding layer 2, thus effectively increasing the thickness of the insulating medium layer between the light-shielding layer 2 and the first metal pattern layer 5, and particularly the thickness of the insulating medium layer at a breakpoint of the edge of the light-shielding layer 2 toward to the visible area, so as to improve the anti-static breakdown performance in the area of the light-shielding layer 2, and to effectively lower the risk of a breakdown of the insulating medium layer on the light-shielding layer 2; and the thickness of the insulating medium layer in the visible area isn't increased as a whole, and no color cast can occur.

In some embodiments of the disclosure, as illustrated in FIG. 1, the width of the orthographic projection of the second insulating medium layer 4 on the base substrate 1 is more than the width of the orthographic projection of the light-shielding layer 2 on the base substrate 1 in the direction from the invisible area to the visible area. The edge of the second insulating medium layer 4 toward to the visible area goes beyond the edge of the light-shielding layer 2, then the second insulating medium layer 4 may better shield the edge area of the light-shielding layer 2 toward to the visible area, to thereby further effectively increase the thickness of the insulating medium layer above the edge area of the light-shielding layer 2 toward to the visible area, and to further effectively improve the anti-static breakdown performance in the edge area of the light-shielding layer 2.

In some embodiments of the disclosure, the width of the orthographic projection of the second insulating medium layer 4 on the base substrate 1 is more than the width of the orthographic projection of the light-shielding layer 2 on the base substrate 1 by 25 μm to 35 μm, in the direction from the invisible area to the visible area. The size of the second insulating medium layer 4 is larger than the size of the light-shielding layer 2 in the direction from the invisible area to the visible area by a size selectable in an appropriate range to thereby improve the anti-static breakdown performance in the edge area of the light-shielding layer 2 without making the edge of the second insulating medium layer 4 going beyond the edge of the light-shielding layer 2 by a too large size, so as to avoid the thickness of the insulating medium layer in the visible area from being affected, thus guaranteeing a display effect of the touch panel.

In some embodiments of the disclosure, the touch panel above further includes: a third insulating medium layer formed on the first metal pattern layer 5, a second metal pattern layer 7 formed on the third insulating medium layer 6, and a protecting layer 8 (for example, over coat layer) formed on the second metal pattern layer 7.

An embodiment of the disclosure further provides a display device including the touch panel according to the embodiment above of the disclosure.

As illustrated in FIG. 1 and FIG. 2, an embodiment of the disclosure further provides a method for fabricating the touch panel. The method includes: coating a photo-resist material layer on the base substrate 1, and patterning the photo-resist material layer to form the light-shielding layer 2 corresponding to the invisible area; forming the first insulating medium layer 3 on the light-shielding layer 2; forming the second insulating medium layer 4 on the first insulating medium layer 3, where the orthographic projection of the second insulating medium layer 4 on the base substrate 1 covers the orthographic projection of the light-shielding layer 2 on the base substrate 1; and forming a metal layer on the second insulating medium layer 5, and patterning the metal layer to form the first metal pattern layer 5.

In the fabricating method above, the base substrate 1 has a visible area and an invisible area, the invisible area is around the visible area, and the light-shielding layer 2 corresponding to the invisible area is arranged on the base substrate 1; and the first insulating medium layer 3 is formed on the light-shielding layer 2 to isolate the light-shielding layer 2 from the first metal pattern layer 5, where the second insulating medium layer 4 corresponding to the light-shielding layer 2 is further arranged between the first insulating medium layer 3 and the first metal pattern layer 5 to completely shield the light-shielding layer 2, that is, both the thickness of the insulating medium layer on the light-shielding layer 2, and the thickness of the insulating medium layer at the edge of the light-shielding layer 2 toward to the visible area are increased to thereby effectively avoid a breakdown arising from electrostatic discharging on metal wires in the invisible area, so as to improve the anti-static breakdown performance in the area of the light-shielding layer, and particularly the thickness of the insulating medium layer at a breakpoint of the edge of the light-shielding layer toward to the visible area is increased to thereby effectively lower the risk of a breakdown of the insulating medium layer on the light-shielding layer 2. Moreover the second insulating medium layer 4 only corresponds to the light-shielding layer 2 and shields the light-shielding layer 2, that is, the second insulating medium layer 4 is not arranged below the first metal pattern layer 5 in the visible area of the touch panel, so the thickness of the insulating medium layer in the visible area isn't increased as a whole, and no color cast can occur.

Specifically the width of the orthographic projection of the second insulating medium layer 4 on the base substrate 1 is more than the width of the orthographic projection of the light-shielding layer 2 on the base substrate 1, in the direction from the invisible area to the visible area.

In some embodiments of the disclosure, in the fabricating method above, forming the second insulating medium layer 4 on the first insulating medium layer 3 includes: coating a second insulating material layer on the first insulating medium layer 3; exposing the second insulating material layer using a mask used for fabricating the light-shielding layer 2, and increasing the exposing to enable the edge of the formed second insulating medium layer 4 to go beyond the edge of the light-shielding layer 2 in the direction from the invisible area to the visible area; and removing the unexposed part of the second insulating material layer, to form the second insulating medium layer 4. The second insulating material layer is exposed using the mask used for fabricating the light-shielding layer 2, and the exposing is increased, that is, the second insulating material layer is over-exposed, so that the size of the contour of the second insulating medium layer 4 formed of the second insulating material is more than the size of the contour of the light-shielding layer 2, so no additional exposure is introduced, thus simplifying a fabrication process.

In some embodiments of the disclosure, the width of the orthographic projection of the second insulating medium layer 4 on the base substrate 1 is more than the width of the orthographic projection of the light-shielding layer 2 on the base substrate 1 by 25 μm to 35 μm, in the direction from the invisible area to the visible area.

In some embodiments of the disclosure, the fabricating method above further includes: forming the third insulating medium layer 6 on the first metal pattern layer 5; forming the second metal pattern layer 7 on the third insulating medium layer 6; and forming the protecting layer 8 on the second metal pattern layer 7.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A touch panel, comprising:
a base substrate;
a light-shielding layer on the base substrate and corresponding to an invisible area;
a first insulating medium layer on the light-shielding layer;
a second insulating medium layer on the first insulating medium layer, wherein an orthographic projection of the second insulating medium layer on the base substrate covers an orthographic projection of the light-shielding layer on the base substrate; and
a first metal pattern layer on the second insulating medium layer.

2. The touch panel according to claim 1, wherein a width of the orthographic projection of the second insulating medium layer on the base substrate is more than a width of the orthographic projection of the light-shielding layer on the base substrate, in a direction from the invisible area to a visible area.

3. The touch panel according to claim 2, wherein the width of the orthographic projection of the second insulating medium layer on the base substrate is more than the width of the orthographic projection of the light-shielding layer on the base substrate by 25 μm to 35 μm, in the direction from the invisible area to the visible area.

4. The touch panel according to claim 1, further comprising:
a third insulating medium layer on the first metal pattern layer;
a second metal pattern layer on the third insulating medium layer; and
a protecting layer on the second metal pattern layer.

5. A display device, comprising the touch panel according to claim 1.

6. A method for fabricating a touch panel, comprising:
coating a photo-resist material layer on a base substrate, and patterning the photo-resist material layer to form a light-shielding layer corresponding to an invisible area;
forming a first insulating medium layer on the light-shielding layer;
forming a second insulating medium layer on the first insulating medium layer, wherein an orthographic projection of the second insulating medium layer on the base substrate covers an orthographic projection of the light-shielding layer on the base substrate; and
forming a first metal pattern layer on the second insulating medium layer.

7. The method according to claim 6, wherein a width of the orthographic projection of the second insulating medium layer on the base substrate is more than a width of the orthographic projection of the light-shielding layer on the base substrate, in a direction from the invisible area to a visible area.

8. The method according to claim 7, wherein forming the second insulating medium layer on the first insulating medium layer comprises:
coating a second insulating material layer on the first insulating medium layer;
exposing the second insulating material layer using a mask used for fabricating the light-shielding layer, and increasing the exposing to enable an edge of the formed second insulating medium layer to go beyond an edge of the light-shielding layer in the direction from the invisible area to the visible area; and
removing an unexposed part of the second insulating material layer, to form the second insulating medium layer.

9. The method according to claim 7, wherein the width of the orthographic projection of the second insulating medium layer on the base substrate is more than the width of the orthographic projection of the light-shielding layer on the base substrate by 25 μm to 35 μm, in the direction from the invisible area to the visible area.

10. The method according to claim 6, further comprising:
forming a third insulating medium layer on the first metal pattern layer;
forming a second metal pattern layer on the third insulating medium layer; and
forming a protecting layer on the second metal pattern layer.
